(19) United States
(12) Patent Application Publication
(10) Pub. No.: US 2020/0293156 A1
(43) Pub. Date: Sep. 17, 2020

(54) STUDIO BUILDER FOR INTERACTIVE MEDIA

(71) Applicant: AppOnboard, Inc., Los Angeles, CA (US)

(72) Inventors: Adam Piechowicz, Los Angeles, CA (US); Jonathan Zweig, Santa Monica, CA (US); Bryan Buskas, Sherman Oaks, CA (US); Abraham Pralle, Seattle, WA (US); Sloan Tash, Long Beach, CA (US); Armen Karamian, Los Angeles, CA (US); Rebecca Mauzy, Los Angeles,, CA (US)

(21) Appl. No.: 16/588,500

(22) Filed: Sep. 30, 2019

Related U.S. Application Data
(60) Provisional application No. 62/819,494, filed on Mar. 15, 2019.

(51) Int. Cl. G06F 3/0482; G06F 3/0484; G06F 3/0481; G06F 3/0488

(52) U.S. Cl. CPC G06F 3/0482; G06F 3/04883; G06F 3/04817; G06F 3/04845

(57) ABSTRACT

A method may include providing a list of assets to an end user and receiving a selection of a first asset as a first scene and a second asset as a second scene. The method may include presenting the first asset. The method may include providing a list of elements, receiving a selection of a gesture area element, receiving a selection of a position on the presentation of the first asset for positioning the gesture area element, and positioning the gesture area element on the selected position. The method may include providing a list of properties including a gesture type property and receiving a selection of a gesture type. The method may include presenting a list of actions, receiving a selection of a transition action to transition from the first scene to the second scene, and associating the transition action with the gesture type in the gesture area element.

### CROSS-REFERENCE TO RELATED APPLICATION

A claim for benefit of priority to the Mar. 15, 2019 filing date of the U.S. Patent Provisional Application No. 62/819,494, titled STUDIO BUILDER FOR INTERACTIVE MEDIA (the '494 Provisional Application), is hereby made pursuant to 35 U.S.C. § 119(e). The entire disclosure of the '494 Provisional Application is hereby incorporated herein.

### TECHNICAL FIELD

Embodiments of the present disclosure relate to the field of interactive media item creation.

### BACKGROUND

Currently, it takes significant experience with coding to be able to create an application that is publishable in a commercial application store.

### SUMMARY

A method may include providing a list of assets to an end user and receiving a selection of a first asset as a first scene and a second asset as a second scene. The method may include presenting the first asset. The method may include providing a list of elements, receiving a selection of a gesture area element, receiving a selection of a position on the presentation of the first asset for positioning the gesture area element, and positioning the gesture area element on the selected position. The method may include providing a list of properties including a gesture type property and receiving a selection of a gesture type. The method may include presenting a list of actions, receiving a selection of a transition action to transition from the first scene to the second scene, and associating the transition action with the gesture type in the gesture area element.

### BRIEF DESCRIPTION OF THE DRAWINGS

Example embodiments will be described and explained with additional specificity and details through the use of the accompanying drawings in which:

FIG. 1 illustrates an example environment to generate an interactive media item;

FIG. 2 illustrates an example system to generate an interactive media item;

FIG. 3 illustrates a first example graphical user interface;

FIG. 4 illustrates a second example graphical user interface;

FIG. 5 illustrates a third example graphical user interface;

FIG. 6 illustrates a fourth example graphical user interface;

FIG. 7 illustrates a fifth example graphical user interface;

FIG. 8 illustrates a sixth example graphical user interface;

FIG. 9 illustrates a seventh example graphical user interface;

FIG. 10 illustrates an eighth example graphical user interface;

FIG. 11 is a flowchart of an example computer-implemented method to generate an interactive media item;

FIG. 12 is a flowchart of another example computer-implemented method to generate an interactive media item; and

FIG. 13 illustrates an example computing device that may be used to generate an interactive media item.

### DETAILED DESCRIPTION

The following disclosure sets forth numerous specific details such as examples of specific systems, components, methods, and so forth, in order to provide a good understanding of several embodiments of the present disclosure. It will be apparent to one skilled in the art, however, that at least some embodiments of the present disclosure may be practiced without these specific details. In other instances, well-known components or methods are not described in detail or are presented in simple block diagram format in order to avoid unnecessarily obscuring the present disclosure. Thus, the specific details set forth are merely examples. Particular implementations may vary from these example details and still be contemplated to be within the scope of the present disclosure.

Conventionally, interactive media creation may require detailed knowledge of computer programming, including knowledge of one or more programming languages. For example, an individual may be required to write computer code which may be compiled and executed or interpreted to run an interactive media item. The individual may write code which, when compiled and executed or interpreted, may result in videos playing at different times, audio playing, and receiving input from a user (e.g., in the form of touch gestures on a screen such as a mobile telephone screen). For example, the individual may desire to create a game for personal consumption, for friends and/or family, or to sell to others. If an individual lacks knowledge about computer programming, creating an interactive media item, such as a game, may be a herculean task with little chance of success.

As an additional example, an individual may be in the marketing department of a company and the company may sell a software tool for smart cellular devices. The individual may have knowledge of how to use the software tool but may not be familiar with how the tool is programmed. Thus, the individual may have difficulty creating an interactive demonstration of how to use the tool in real world scenarios.

Alternatively, even if an individual has detailed knowledge of computer programming, the individual may wish to create a demonstration of an in-progress or completed program or application (e.g., a “demo” or “app demo”). It may be difficult to separate out source code needed for the demo from source code that is extraneous to the demo. For example, many software modules may be relevant to the demo while others may not be relevant. Alternatively, the individual may desire to create multiple demos for a single application (e.g., a demo for each level of a game). Separating media related to a demo from other media may be a laborious task or may be inefficient. Some videos, images, and/or sounds may be relevant to the completed application as a whole but may not be relevant to a particular desired demo. If the individual were to include both the relevant and irrelevant source code and/or media files, the demo may be prohibitively large (e.g., the demo may be as large as, or almost as large as, the complete program). Some digital application stores, such as those provided by Apple, Google, and Microsoft, may place limitations on download sizes for app demos. Alternatively, users may not desire to download a full program prior to trying it out, so the individual may wish to limit the size of the app demo to increase the likelihood that a user will download it.

Embodiments of the present disclosure may help users create interactive media items, including application demos or even full applications, without knowledge of coding. For example, a user may select different media items, place the media items into different scenes, and connect the media items using different transitions without knowing any programming language. The techniques and tools described herein may create the required source code to generate an interactive media item based on selections made by the user and without the user typing even one line of code.

Using the techniques and tools described herein, anyone can create an interactive media item, such as an app demo, which is often the first step in bringing an idea to life and onto commercial app stores. App demos also enable big apps to become instant and shareable. App demos generated using the techniques and tools described herein may be easier to create and/or smaller than app demos generated by modifying the source code associated with the completed application. Alternatively, a user can create an interactive demonstration of a product, such as a software tool. The user may record screen captures as media files (e.g. one or more video files) of the user interacting with the software tool. The user may then combine the media files with gesture elements to create an interactive example of how to use the software tool as an interactive media item.

Additionally or alternatively, a user can create a game. The user may obtain images, video, and/or audio as media items. For example, the user may take pictures or video using a camera included in a smartphone. Alternatively, the user may draw pictures in a digital art environment. The user may position the media items into different scenes and connect the scenes with transitions. In some embodiments, a user may be able to combine assets, such as videos, audio, and images, together with gesture elements, to build a functioning, interactive media item to share with others.

Various embodiments of the present disclosure may improve the functioning of computer systems by, for example, reducing the size of app demos that may be stored in an online marketplace. Reducing the size of app demos may result in fewer computing resources required to store and download app demos or other interactive media items. Additionally, some embodiments of the present disclosure may facilitate more efficient creation of interactive media items by computer programming novices, who may not be required to learn programming languages in order to create an interactive media item.

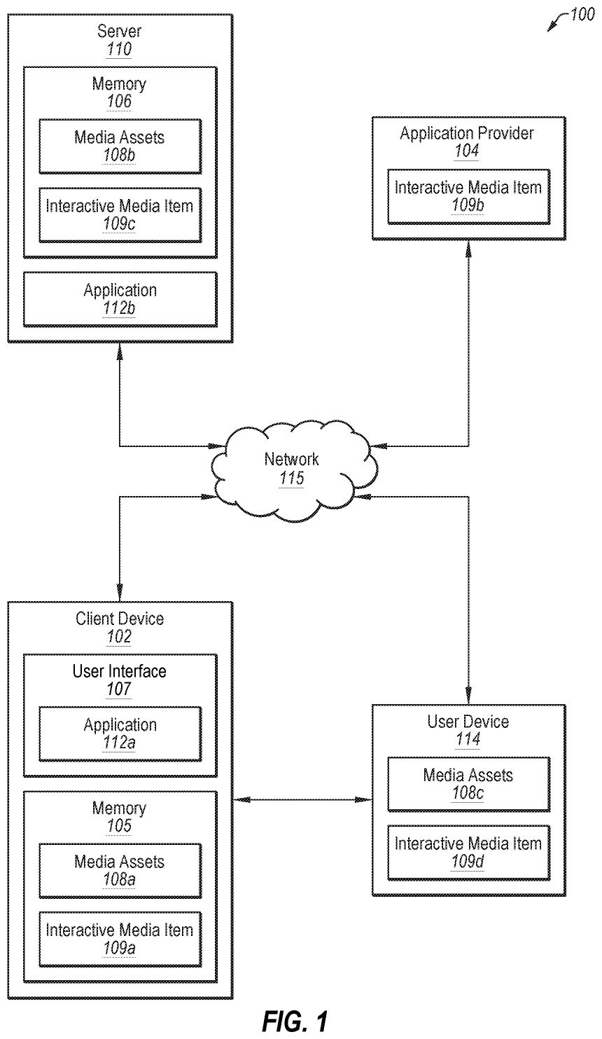

FIG. 1 illustrates an example system 100 in which embodiments of the present disclosure can be implemented. The system 100 includes a client device 102, an application provider 104, a server 110, a user device 114, and a network 115.

The client device 102 may include a computing device such as a PC, a laptop, a mobile phone, a smart phone, a tablet computer, a netbook computer, an e-reader, a PDA, or a cellular phone etc. While only a single client device 102 is shown in FIG. 1, the system 100 may include more than one client device 102. For example, in some embodiments, the system 100 may include two or more client devices 102. The client device 102 may provide a user with the user interface 107 through which the user may create an interactive media item 109a. Using the user interface 107, a user may select media assets 108a, create scenes, place gesture elements, and instruct the client device 102 to generate the interactive media item 109a, among other activities.

The application provider 104 may include one or more computing devices, such as a rackmount server, a router computer, a server computer, a PC, a mainframe computer, a laptop computer, a tablet computer, a desktop computer, etc., data stores (e.g., hard disks, memories, databases), networks, software components, and/or hardware components. In some embodiments, the application provider 104 may include a digital store that provides applications to tablet computers, desktop computers, laptop computers, smart phones, etc. For example, in some embodiments, the application provider 104 may include the digital stores provided by Apple, Google, Microsoft, or other providers.

The server 110 may include one or more computing devices, such as a rackmount server, a router computer, a server computer, a personal computer, a mainframe computer, a laptop computer, a tablet computer, a desktop computer, etc., data stores (e.g., hard disks, memories, databases), networks, software components, and/or hardware components.

The user device 114 may include a computing device such as a personal computer (PC), a laptop, a mobile phone, a smart phone, a tablet computer, a netbook computer, an e-reader, a personal digital assistant (PDA), or a cellular phone etc. While only a single user device 114 is shown in FIG. 1, the system 100 may include more than one user device 114. For example, in some embodiments, the system 100 may include two or more user devices 114.

In some embodiments, the network 115 may include a public network (e.g., the Internet), a private network (e.g., a local area network (LAN) or a wide area network (WAN)), a wired network (e.g., an Ethernet network), a wireless network (e.g., an 802.11 network, Bluetooth network, or a Wi-Fi network), a cellular network (e.g., a Long Term Evolution (LTE) or LTE-Advanced network), routers, hubs, switches, server computers, and/or a combination thereof.

The client device 102 may include a memory 105. In some embodiments, the server 110 may include a memory 106. The memory 105 and the memory 106 may each include a memory (e.g., random access memory), a cache, a drive (e.g., a hard drive), a flash drive, a database system, a shared memory (e. g., memory 105 and memory 106 may be the same memory that is accessible by both the client device 102 and the server 110) or another type of component or device capable of storing data.

The memory 105 may store electronic items, such as media assets 108a and an interactive media item 109a. The media assets 108a may include electronic content such as pictures, videos, GIFs, or any other electronic content. In some embodiments, the media assets 108a may include a variety of assets that may be combined to be included in the interactive media item 109a. In these and other embodiments, the media assets 108a may include images, video, and/or audio, which a user may select for inclusion in a completed interactive media item. The media assets 108a may be obtained by a video camera, a smart phone, or any other appropriate device for obtaining media (not shown). For example, in some embodiments, the media assets 108a may be photographs, video, and/or audio files captured by a still camera, video camera, and/or microphone. Alternatively or additionally, in some embodiments, the media assets 108a may be digital creations (e.g., a drawing created in a digital format). The media assets 108a may be stored in any format or file type, such as, for example, .JPEG, .TIFF, .MP3, .WAV, .MOV, .MPEG, .MP4, etc.

In some embodiments, the interactive media item 109a may include or be related to a demonstration of a game, an application, or another feature for a mobile device or another electronic device. In some embodiments, the interactive media item 109a may include various video segments (e.g., the media assets 108a) that are spliced together to generate interactive media for demonstrating portions of a game, use of an application, or another feature of a mobile device or an electronic device. As another example, the interactive media item 109a may include a training video that permits a user to simulate training exercises. The interactive media item 109a may include any number and any type of media assets 108a that are combined into the interactive media item 109a.

In some embodiments, the user interface 107 may be implemented to organize, arrange, connect, and/or combine media assets 108a to create the interactive media item 109a via a first application 112a or a second application 112b. The first application 112a and the second application 112b are referred to in the present disclosure as the application 112. For example, the user interface 107 may provide access to the first application 112a stored on the client device 102 or the second application 112b stored on the server 110. The first application 112a and the second application 112b are referred to in the present disclosure as the application 112. In some embodiments, the first application 112a and the second application 112b may be the same application stored in different locations. For example, the first application 112a may be a locally installed application. In these and other embodiments, the first application 112a may be installed on the client device 102. The operations performed by the first application 112a to generate the interactive media item 109a may be executed on a processor local to the client device 102. In contrast, the second application 112b may be a web application hosted by a remote device, the server 110, which is displayed through the user interface 107 on a display associated with the client device 102. The application 112b may include a web browser that can present functions to a user. As a web browser, the application 112b may also access, retrieve, present, and/or navigate content (e.g., web pages such as Hyper Text Markup Language (HTML) pages, digital media items, etc.) via the network 115. The operations performed by the second application 112b to generate an interactive media item may be performed by a processor remote from the client device 102, for example a processor associated with the server 110.

The client device 102 may display the application 112 (i.e., either the first application 112a running locally on the client device 102 or the second application 112b running remotely on the server 110) via the user interface 107 to a user to guide the user through a process to organize, arrange, connect, and/or combine media assets 108a stored in the memory 105 of the client device 102 to create the interactive media item 109a, which may also be stored in the memory 105 of the client device 102. Alternatively, in some embodiments, the application 112 may guide the user through a process to organize, arrange, connect, and/or combine media assets 108b stored in the memory 106 of the server 110 to create the interactive media item 109c, which may also be stored in the memory 106 of the server 110. Alternatively, in some embodiments, the application 112 may guide the user through a process to organize, arrange, connect, and/or combine media assets 108c stored on the user device 114 to create the interactive media item 109a and/or the interactive media item 109b. The media assets 108a, the media assets 108b, and the media assets 108c (collectively the media assets 108) may be the same media assets but stored in different locations. Similarly, the interactive media item 109a, the interactive media item 109b, the interactive media item 109c, and the interactive media item 109d (collectively the interactive media item 109d) may be the same interactive media item stored in different locations.

During operation of the system 100, the client device 102 may select media assets 108a for use in production of the interactive media item 109a. Using the user interface 107, video assets, audio assets, image assets, and/or other assets may be combined, organized, and/or arranged to produce an interactive media item. For example, assets may be combined (e.g., image assets may be placed on top of video assets, and audio assets may be combined with image and/or video assets). Alternatively or additionally, media assets 108a may be placed in scenes and a user may use the application 112 via the user interface 107 to generate transitions between scenes. For example, a first scene may be created using a first media asset and a second scene may be created using a second media asset. Using the application 112, a transition may be created between the first scene and the second scene. For example, the transition may be based on touch interaction such as, for example, receiving touch input in the form of a tap on a particular part of the first scene. In some embodiments, the various scenes together with their corresponding media assets 108a and transitions may be combined to generate a completed interactive media item 109a. The interactive media item 109a may be sent from the client device 102 to the application provider 104 and to the user device 114. Alternatively or additionally, in some embodiments, the interactive media item 109a may be sent from the client device 102 to the application provider 104 and stored as the interactive media item 109b. The interactive media item 109b may be sent by the application provider 104 to the user device 114, which may be stored as the interactive media item 109d. The user device 114 may execute code of the interactive media item 109d (e.g. in an application).

Alternatively or additionally, in some embodiments, the interactive media item 109 may be generated at the server 110 using the application 112b as an internet-based application or web app. In these and other embodiments, the client device 102 and/or the user device 114 may communicate with the server 110 via the network 115 and may present the application 112b on a display associated with the client device 102 and/or the user device 114. For example, a user may use the user device 114 to access the application 112b as a web app to select media assets 108c for use in generating the interactive media item 109c. In these and other embodiments, the media assets 108c may be copied or moved to the server 110 as the media assets 108b. Alternatively, a user may use the client device 102 to access the application 112b as a web app to select media assets 108a for use in generating the interactive media item 109c. As described above, a user may use the application 112b to combine various assets, organize various assets into different scenes, and/or arranged various assets to produce an interactive media item. The user may also use the application 112b to generate transitions between scenes. The server 110 may then combine the media assets 108 with the transitions and other elements added by a user using the application 112b to generate the interactive media item 109c. The interactive media item 109c may be sent from the server 110 to the application provider 104 and to the user device 114.

In some embodiments, the user device 114 may operate as a source of media assets 108. For example, the user device 114 may send the media assets 108c to the client device 102 and/or the server 110. In at least one embodiment, the media assets 108b and/or the media assets 109d may be imported to the media assets 108a on the client device 102 and made available for use in the creation of an interactive media item 109. Additionally or alternatively, the user device 114 may be used to execute or run the interactive media item 109d. In these and other embodiments, the user device 114 may obtain the interactive media item 109d by downloading the interactive media item 109b from the application provider 104 via the network 115.

In some embodiments, the application 112 may transfer the interactive media item 109a directly to the user device 114 via over the air communication techniques. In other embodiments, the application 112 may transfer the interactive media item 109a to the server 110, the application provider 104, and the user device 114 via the network 115 or directly. For another example, the client device 102 may access the interactive media item 109c stored in the memory 106 on the server 110 via the network 115.

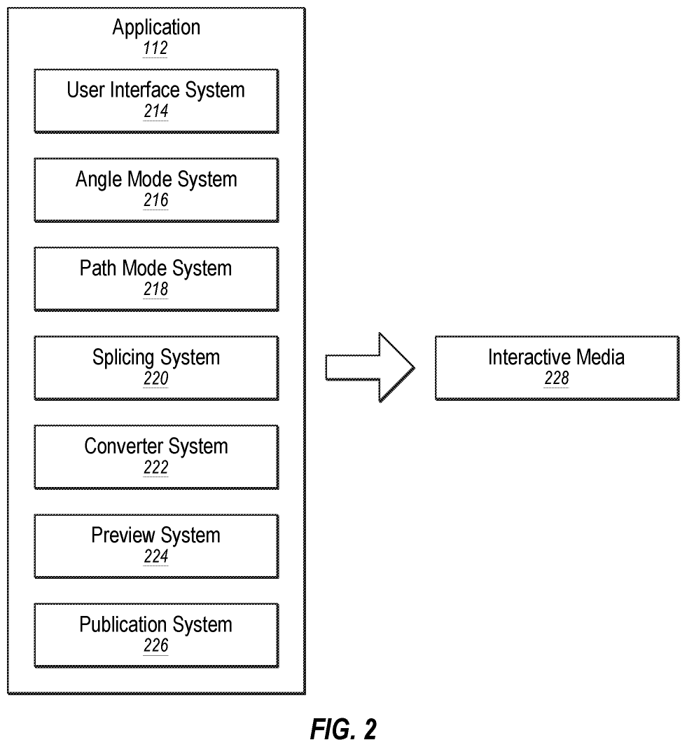

FIG. 2 is a block diagram illustrating an example application 112 of the system 100 of FIG. 1, in accordance with some embodiments of the present disclosure. The application 112 may be implemented to generate interactive media 228, which may include the interactive media item and/or the media assets 108 of FIG. 1. The application 112 may include a user interface system 214, an angle mode system 216, a path mode system 218, a splicing system 220, a converter system 222, a preview system 224, and a publication system 226. More or fewer of the various systems may be included in the application 112 without loss of generality. For example, some of the systems may be combined into a single system, or any of the systems may be divided into two or more systems. In one implementation, one or more of the systems may reside on different computing devices (e.g., different server computers).

The application 112 may combine media assets, such as video assets, audio assets, and image assets, to produce an interactive media item. Using the application 112, transitions between scenes of the interactive media may be defined based on playback of videos ending, playback of audio ending, receiving input in the form of gestures, and/or based on counters.

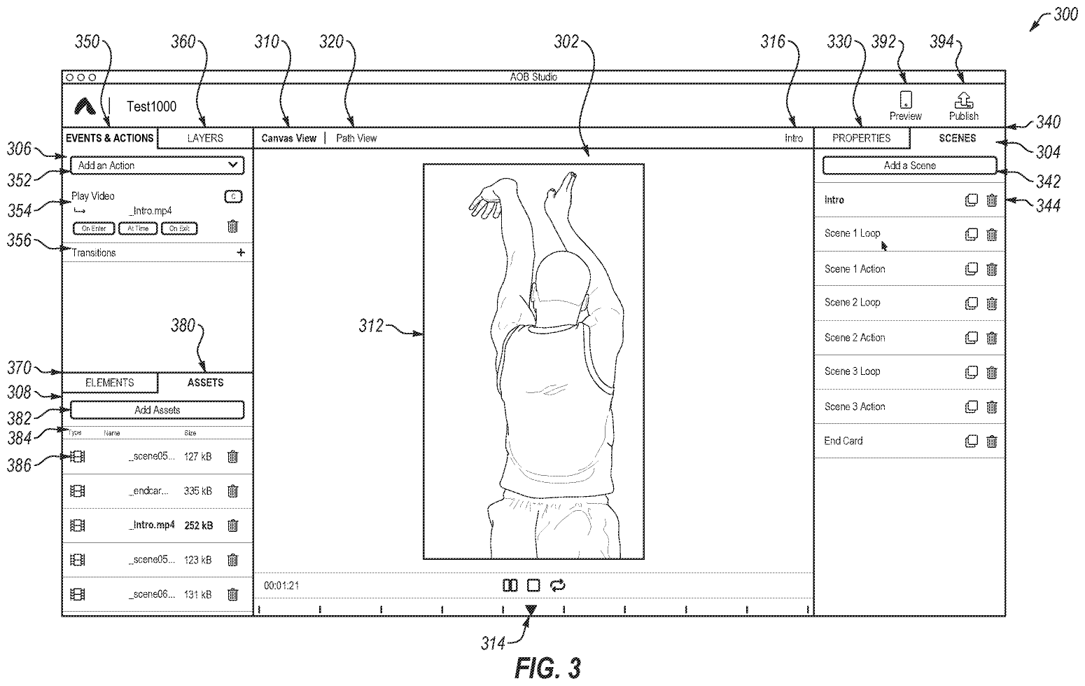

The user interface system 214 may present various menus to a user to allow a user to combine media assets, arrange media assets, connect media assets using transitions, and designate triggers for transitions, such as touch gestures and/or other triggers. Various illustrations of the user interface system 214 are illustrated in FIGS. 3-10 and are described below.

The angle mode system 216 may enable a user to create gesture elements in an interactive media item which include different angles of a circle. For example, an angle may include a first angle pair and a second angle pair. In some embodiments, the first angle pair and the second angle pair may overlap. Alternatively or additionally, in some embodiments, the first angle pair and the second angle pair may not overlap. In these and other embodiments, different transitions may occur depending on which angle pair receives input and the speed of the input. For example, if the interactive media item detects a swipe in the first angle pair, the interactive media item may transition to a first scene. Alternatively, if the interactive media item detects a swipe in the second angle pair, the interactive media item may transition to a second scene. Alternatively or additionally, the interactive media item may also detect a velocity of a swipe. In these and other embodiments, the velocity of the swipe may result in a different transition. For example, the interactive media item may transition to a first scene in response to detecting a low velocity swipe in the first angle pair and may transition to a third scene in response to detecting a high velocity swipe in the first angle pair.

The path mode system 218 may enable a user to create gesture elements in an interactive media item which may include a sequence of locations forming a path along which input, such as a finger dragging across a touch screen, may be identified. For example, a path may proceed from a first location on a display to a second location on a screen to a third location on a screen and so on. In these and other embodiments, different transitions may occur depending on the completeness of the path. As a first example, the interactive media item may receive input from a touch screen indicating a trace from the first location on the path through the second location on the path. In these and other embodiments, the interactive media item may proceed from a first particular scene to a second particular scene. As a second example, the interactive media item may receive input from a touch screen indicating a trace from the first location on the path through the second location, then through the third location on the path. In these and other embodiments, the interactive media item may proceed from a first particular scene to a third particular scene. Thus, the degree to which the path is completed may result in different outcomes in the interactive media item.

The splicing system 220 may receive the data output by any of the user interface system 214, the angle mode system 216, the path mode system 218. The data may include multiple assets. Video assets are described as an example. Any type of asset, and any combination of assets may be used. The splicing system 220 may combine two or more assets. In at least one embodiment, the splicing system 220 may concatenate two or more assets to create an interactive media asset. When combining two or more assets, the splicing system 220 may also create instructions and/or metadata that a player or software development kit (SDK) may read to know how to access and play each asset. In this manner, each asset is combined while still retaining the ability to individually play each asset from a combined file. In some embodiments, splicing two or more videos may help overcome performance issues on different software and/or hardware platforms. In particular, the splicing system 220 may improve the playback of interactive media items that include video on mobile telephones.

Each video asset may include multiple frames and may include information that identifies a number of frames associated with the corresponding video asset (e.g., a frame count for the corresponding video asset). The frame count may identify a first frame and a last frame of the corresponding video assets. The splicing system 220 may use the frames identified as the first frame and the last frame of each asset to determine transition points between the different video assets. For example, the last frame of a first video asset and a first frame of a second video asset may be used to determine a first transition point that corresponds to transitioning from the first video asset to the second video asset.

In some embodiments, the splicing system 220 may generate multiple duplicate frames of each frame identified as the last frame of corresponding video assets. For example the multiple duplicate frames of the last frame of the first video asset may be generated. The duplicate last frames may be combined into a duplicate video asset and placed in a position following the last frame of the corresponding video asset. For example, each duplicate frame of the last frame of the first video asset may be made into a first duplicate video asset and placed in a position just following the first video asset. As another example, each duplicate frame of the last frame of the second video asset may be made into a second duplicate video asset and placed in a position just following the second video asset.

The duplicate frames may be generated to account for differences in video player configurations. For example, some video players may transition to a subsequent frame immediately after playing a last frame of a video asset. As another example, some video players may wait a number of frames or a period of time (or may suffer from a delay in transition) before transitioning to a subsequent frame after playing a last frame of a video asset. The duplicate frames may be viewed by a user during this delay to prevent a cut or black scene (or an incorrect frame) being noticeable to a viewer.

The splicing system 220 may determine an updated frame count for the first frame and last frame for each video asset. For example, the updated frame count for last frame of the first video asset may be equal to the number of frames in the first video asset plus the number of frames in the duplicate first video asset. As another example, the updated frame count for last frame of the second video asset may be equal to the number of frames in the first video asset plus the number of frames in the duplicate first video set plus the number of frames in the second video asset plus the number of frames in the second duplicate video asset. As yet another example, the updated frame count for the first frame of the second video asset may be equal to the updated frame count for the last frame of the first video asset plus one.

The splicing system 220 may splice each video asset and duplicate video asset into an intermediate interactive media asset in a first particular format. In some embodiments, the splicing system 220 may concatenate each of the video assets and duplicate video assets into the intermediate interactive media asset. For example, the intermediate interactive media may be generated in a TS format or any other appropriate format. The splicing system 220 may also convert the intermediate interactive media to a second particular format. For example, the intermediate interactive media may be converted to MP4 format or any other appropriate format. In some embodiments, the splicing system 220 may convert the intermediate interactive media into a particular format based on a destination device compatibility. For example, mobile telephones manufactured by one company may be optimized to play h.264 encoded video and the splicing system 220 may encode video using the h.264 encoding if the completed interactive media item will be distributed to devices of the company. The splicing system 220, as part of converting the intermediate interactive media to the second particular format, may label the frames corresponding to the updated frame count of each first frame of the video asset as a key frame. In some embodiments, key frames may indicate a change in scenes or other important events in the intermediate interactive media asset. In some embodiments, labeling additional frames as key frames may help to optimize playback of an interactive media item on a device. For example, labeling additional frames as key frames may speed up playback resumption when transitioning between different video clips and/or when transitioning to a different point in time of a single video clip.

The converter system 222 may convert the convert the interactive media item to any format, such as HTML5. In some embodiments, converter system 222 may obtain the script of the interactive media item, which may be in a format such as a JavaScript Object Notation file, and may obtain the media assets of the interactive media item. The converter system 222 may verify the script by verifying the views/classes in the script and the states in the script, which may correspond with scenes created using the user interface system 214. After verifying the script, the converter system 222 may parse the script and create new objects based on the objects in the script. The converter system 222 may then encode the new objects together with the media assets to generate a single playable unit. In some embodiments, the single playable unit may be in the HTML5 format. Alternatively or additionally, in some embodiments, the single playable unit may be in an HTML5 and JavaScript format.

The preview system 224 may include a system to provide a preview of the interactive media item. A benefit of the preview system 224 is the ability to view an interactive media item before it is published to an application marketplace or store. The preview system 224 may receive a request, such as via a GUI, to preview the interactive media item. In response to receiving input selecting a preview button, for example, a matrix barcode, such as a Quick Response (QR) Code may be displayed. In these and other embodiments, the matrix code may be associated with a download link to download the completed interactive media. The interactive media item may be provided to a client device, such as the client device 102 for preview. In at least one embodiment, as updates to the interactive media item may be made, those updates may be pushed to the client device in real time such that the client device does not need to request the preview a second time.

The publication system 226 may receive the intermediate interactive media asset. To publish the intermediate interactive media asset as the interactive media item 228, certain identification information for or the format of the identification information of the intermediate interactive media asset may need to match identification information or the format of the identification information in the corresponding app, game, or other function for an electronic device. For example, an interactive media item 228 may be generated, updated, or otherwise edited from the intermediate interactive media asset to match a particular format of the corresponding app, game, platform, operating system, executable file, or other function for an electronic device.

To match the identification information in the intermediate interactive media asset, the publication system 226 may receive identification information associated with the corresponding app, game, or other function for an electronic device. For example, the publication system 226 may receive format information associated with the corresponding app, game, platform, operating system, executable file, or other function for an electronic device. The publication system 226 may extract the identification information for the corresponding app, game, platform, operating system, executable file, or other function for an electronic device. In some embodiments, the identification information may include particular information that includes a list of identification requirements and unique identifiers associated with the corresponding app, game, platform, operating system, executable file, or other function for an electronic device. For example, the identification information may include Android or iOS requirements of the corresponding app, game, platform, operating system, executable file, or other function for an electronic device.

The publication system 226 may also open a blank interactive media project. In some embodiments, the identification information associated with the blank interactive media project may be removed from the file. In other embodiments, the identification information associated with the blank interactive media project may be empty when the blank interactive media project is opened. The publication system 226 may insert the identification information extracted from the corresponding app, game, platform, operating system, executable file, or other function for an electronic device into the blank interactive project along with the intermediate interactive media asset.

The publication system 226 may compile the blank interactive project including the intermediate interactive media asset and the identification information extracted from the corresponding app, game, platform, operating system, executable file, or other function for an electronic device. In some embodiments, the publication system 226 may perform the compiling in accordance with an industry standard. For example, the publication system 226 may perform the compiling in accordance with an SDK. The compiled interactive project may become the interactive media 228 once signed with a debug certificate, a release certificate, or both by a developer and/or a provider such as a provider associated with the application provider 104 of FIG. 1.

The publication system 226 may directly send the interactive media item to an application provider (e.g., application provider 104 of FIG. 1), such application stores provided by Google, Apple, or Microsoft, among others.

FIGS. 3-10 illustrate embodiments of example user interfaces (UIs) at various stages of the production of an interactive media item, in accordance with aspects of the present disclosure. The example UIs may be presented by and/or displayed within a web browser when the user accesses the internet-based content platform via the web browser. In another embodiment, the example UIs may be an interface presented by a media viewer (e.g., an app, an application, a program, a software module/component, etc., that may be used to create an interactive media item, play, and/or consume an interactive media item). Some example UIs include control elements in the form of a button (e.g., a button for importing an asset). However, it should be noted that various other control elements can be used for selection by a user such as a check box, a link, or any other user interface elements.

As illustrated in FIG. 3, the UI 300 may include multiple areas, such as a Canvas/Path area 302, a Properties/Scenes area 304, an Events & Actions/Layers area 306, and an Elements/Assets area 308 (collectively the areas 302, 304, 306, and 308). Although the UI 300 is illustrated with four areas 302, 304, 306, and 308, in some embodiments, the UI may include more or fewer areas. Alternatively or additionally, in some embodiments, one or more of the areas 302, 304, 306, and 308 may be collapsible, expandable, or hideable. For example, in some embodiments, the Properties/Scenes area 304 may be hidden from view in response to receiving input to hide the Properties/Scenes area 304. In some embodiments, the UI 300 may also include a Preview button 392 and a Publish button 394.

Each of the areas 302, 304, 306, and 308 may include multiple tabs which may be presented or selected. For example, in some embodiments, the Canvas/Path area 302 may include a Canvas View tab 310 and a Path View tab 320; the Properties/Scenes area 304 may include a Properties tab 330 and a Scenes tab 340; the Events & Actions/Layers area 306 may include an Events & Actions tab 350 and a Layers tab 360; and the Elements/Assets area 308 may include an Elements tab 370 and an Assets tab 380 (collectively the tabs 310, 320, 330, 340, 350, 360, 370, and 380). In some embodiments, selection of a particular tab may change what is presented in the corresponding area. For example, selection of the Canvas View tab 310 may change what is presented in the Canvas/Path area 302 versus selection of the Path View tab 320. Although each of the areas 302, 304, 306, and 308 are illustrated with two tabs of the tabs 310, 320, 330, 340, 350, 360, 370, and 380, in some embodiments, one or more of the areas 302, 304, 306, and 308 may include one tab, no tabs, or any number of tabs.

The UI 300 may include, in the Elements/Assets area 308 under the Assets tab 380, an Add Assets button 382. In these and other embodiments, when the UI 300 receives input selecting the Add Assets button 382, various pop-up dialog boxes may appear and may allow a user to select a variety of assets, such as video assets, image assets, and audio assets. Once selected, the assets and details of the assets may be presented under an asset menu heading 384 in an asset list 386. The asset menu heading 384 may include multiple categories, such as the type of the asset (e.g., video, audio, image, etc.), the name of the asset, and the size of the asset (e.g., in disk space used, such as kilobytes (KB), megabytes (MB), or in terms of length (e.g. how long a video or audio file is or how large an image file is in pixel count). The asset list 386 may include a list of all assets associated with the current project and may additionally include an option to delete specific assets.

In these and other embodiments, the UI 300 may also include, in the Properties/Scenes area 304 in the Scenes tab 340, an Add a Scene button 342. In these and other embodiments, when the UI 300 receives input selecting the Add a Scene button 342, the UI 300 may add an additional scene to a list of scenes 344 and may provide an input field for a user to enter a name for the scene. The scenes associated with the project may be presented in the list of scenes 344. The list of scenes 344 may include the names of each of the scenes associated with the project and an option to copy or delete each scene. In some embodiments, in response to receiving a selection of one of the scenes in the list of scenes 344, the UI 300 may highlight or shade the selected scene and may present the selected scene in the Canvas/Path area 302 in the Canvas View tab 310.

The UI 300 may present a scene in the Canvas/Path area 302 in the Canvas View tab 310. In these and other embodiments, a scene may not include any associated images to be presented in the Canvas/Path area 302 in the Canvas View tab 310 prior to the addition of an asset to the scene. In response to receiving a selection of an asset from the list of assets 386 and receiving input in the form of dragging the asset from the list of assets to the Canvas/Path area 302 in the Canvas View tab 310, the asset may be added to the scene and the UI 300 may present the asset in the Canvas/Path area 302 in the Canvas View tab 310 as the scene 312. The UI 300 may include, in the Canvas/Path area 302 under the Canvas View tab 310, a scene identifier 316 and asset playback controls 314. In some embodiments, the UI 300 may present the asset playback controls 314 when video assets and/or audio assets have been added to the scene 312 but may not present the playback controls 314 when no assets have been added to the scene 312 or when only image assets have been added to the scene 312. In these and other embodiments, the playback controls 314 may include an asset length indicating the length in time of the asset, a button to play the asset, a button to pause the asset, and a button to turn on auto-replay of the asset. Alternatively or additionally, in some embodiments, the playback controls 314 may include a playback bar indicating the current progress of playback of the asset.

The UI 300 may also include, in the Events & Actions/Layers area 306 in the Events & Actions tab 350, an Add an Action button 352. Actions may include playing assets (e.g., playing a video asset associated with a scene or playing an audio asset associated with a scene). In some embodiments, the actions in the Events & Actions tab 350 may include playing a video, stopping a video, performing an animation, playing a sound, stopping a sound, playing music, stopping music, setting a counter, stopping a counter, setting text on a label, setting text on a label with a counter, setting a trigger, clearing a trigger, and/or transitioning to a scene. The UI 300 may also include, in the Events & Actions/Layers area 306 in the Events & Actions tab 350, a list of actions 354. In some embodiments, the list of actions 354 may include the actions associated with the current scene 312. Alternatively or additionally, in some embodiments, the list of actions 354 may include all actions associated with the current project (i.e., the actions associated with each scene in the list of scenes 344). The actions in the list of actions 354 may include a type of action (e.g., “Play Video”), a name of the asset associated with the action, a trigger for the action (e.g., “On Enter,” “At Time,” or “On Exit”), and/or an option to delete an action. In some embodiments, the UI 300 may also include a list of transitions 356.

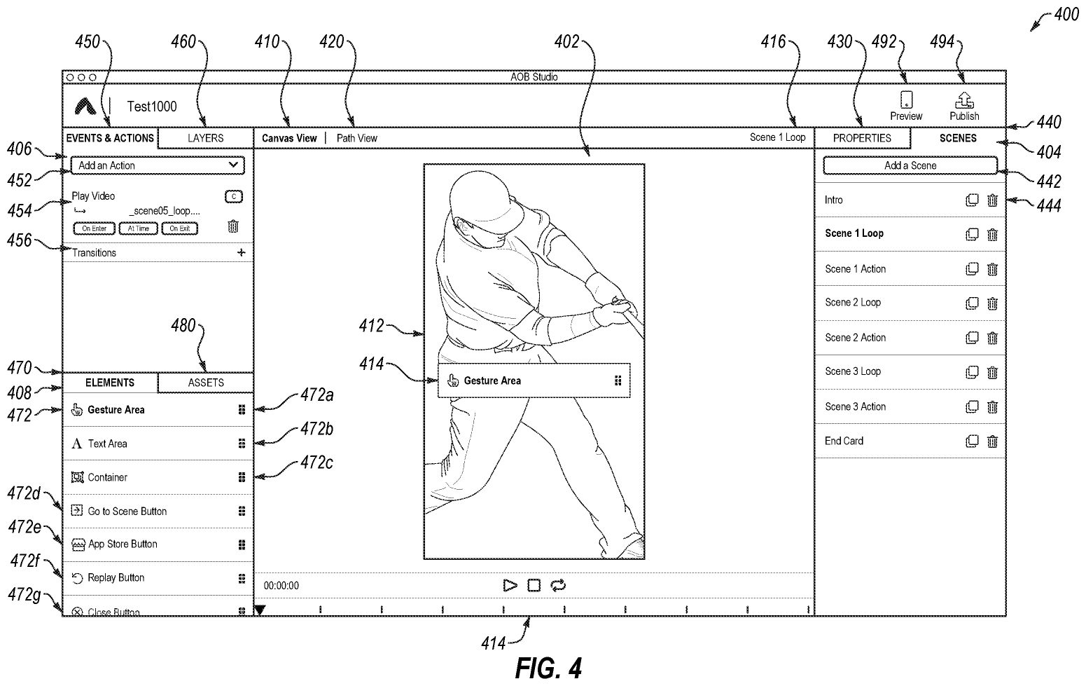

As illustrated in FIG. 4, the UI 400, which may correspond with the UI 300, may present different options and/or buttons in response to different selections of tabs. For example, to reach the UI 400 from the UI 300 of FIG. 3, a user may select the “Scene 1 Loop” scene from the list of scenes 444, and the UI 400 may present the “Scene 1 Loop” scene in the Canvas/Path area 402 in the Canvas View tab 410 as the scene 412. Additionally, the UI 400 may receive input selecting a video asset and placing the video asset in the scene 412 and adding a “Play Video” action to the scene 412. In response to receiving input selecting the Elements tab 470 of the Elements/Assets area 408, the UI 400 may present a list of elements 472 in the Elements tab 470. In some embodiments, the list of elements 472 may include elements such as a Gesture Area element 472A, a Text Area element 472B, a Container element 472C, a Go to Scene Button element 472D, an App Store Button 472E, a Replay Button 472F, a Close Button 472G, and an Open Uniform Resource Locator (URL) Button element (also called an open link element) (not illustrated in FIG. 4). Alternatively or additionally, in some embodiments, the list of elements 472 may include more, fewer, or different elements.

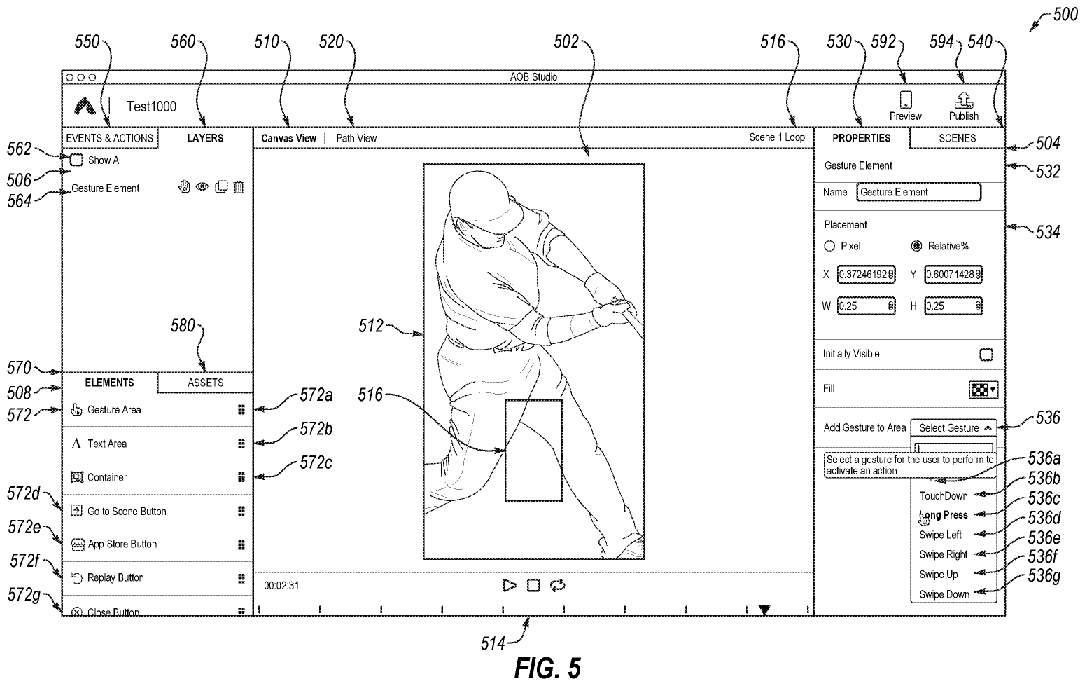

In some embodiments, the list of elements 472 may include a Gesture Area element 472A. In some embodiments, in response to receiving input dragging an element, such as the Gesture Area element 472A, to the Canvas View tab 410, a positioned Gesture Area 416 may be added to the scene 412. In these and other embodiments, the Canvas View tab 410 may display a shape of the positioned Gesture Area 416. In these and other embodiments, the positioned Gesture Area 416 may include multiple anchor points. In these and other embodiments, in response to receiving input inside the positioned Gesture Area 416 such as a mouse hold, the positioned Gesture Area 416 may be repositioned within the scene 412. Alternatively or additionally, in response to receiving input on an anchor of the positioned Gesture Area 416 such as a mouse hold, the positioned Gesture Area 416 may be resized within the scene 412. For example, the positioned Gesture Area 416 may be moved to the upper left corner of the scene 412 and may be resized to fill the entire scene 412. In some embodiments, after an element such as the Gesture Area 416 is added to a scene, the Layers tab 460 in the Events & Actions/Layers area 406 may be presented, as illustrated in FIG. 5. In these and other embodiments, the Properties tab 430 of the Properties/Scenes area 404 may also be presented, as illustrated in FIG. 5.

In some embodiments, the list of elements 472 may include a Text Area element 472B. In these and other embodiments, the Text Area element 472B may allow a user to add text areas to the scene 412. For example, in some embodiments, the UI 400 may receive input selecting the Text Area element 472B and dragging the Text Area element 472B to a particular position on the scene 412. A positioned text area may provide a field to receive input in the form of text. Additionally or alternatively, in some embodiments, a positioned text area may be repositioned, may be resized, may have a background color and/or transparency, and text in the positioned text area may be edited, resized, recolored, highlighted, inverted, or angled. As discussed above with respect to the Gesture Area element 472A, after placing a Text Area element 472B on the scene 412, the Layers tab 460 and the Properties tab 430 may be presented in their respective areas 406 and 404.

In some embodiments, the list of elements 472 may include a Container element 472C. In these and other embodiments, the Container element 472C may allow a user to combine multiple elements of the list of elements 472 into a single element, which may make organization of elements easier. For example, the Container element 472C may allow a user to nest other elements. In some embodiments, multiple images and/or videos may be placed onto a single scene. For example, an image asset may be placed on a video asset on the scene. In these and other embodiments, in the Layers tab 460, the image asset may be nested into a positioned container. Similarly, a positioned App Store Button may be nested into the positioned container. In some embodiments, a positioned container may not be associated with a particular scene and instead may be associated with the current project. In these and other embodiments, the positioned container and/or any elements nested within the container may be made visible on each individual scene and/or made invisible on each individual scene. For example, in some embodiments, the UI 400 may receive input selecting the Container element 472C and dragging the Container element 472C to a particular position on the scene 412. Additional elements may be dragged into a positioned container. Additionally or alternatively, in some embodiments, a positioned container may be repositioned and/or may be resized. In some embodiments, elements that have been placed within a container may be removed. As discussed above with respect to the Gesture Area element 472A, after placing a Container element 472C on the scene 412, the Layers tab 460 and the Properties tab 430 may be presented in their respective areas 406 and 404.

In some embodiments, the list of elements 472 may include a Go to Scene Button element 472D. In these and other embodiments, the Go to Scene Button element 472D may allow a user to create a button to directly go to a particular scene in the current project. For example, in some embodiments, the UI 400 may receive input selecting the Go to Scene Button element 472D and dragging the Go to Scene Button element 472D to a particular position on the scene 412. A positioned Go to Scene Button may provide a field to receive input in the form of a destination scene. In these and other embodiments, in a completed interactive media item, in response to receiving input selecting a positioned Go to Scene Button, the interactive media item may transition to the destination scene designated. Additionally or alternatively, in some embodiments, a positioned Go to Scene Button may be repositioned, may be resized, may have a background color and/or transparency, and may include text which may be edited, resized, recolored, highlighted, inverted, or angled. As discussed above with respect to the Gesture Area element 472A, after placing a Go to Scene Button element 472D on the scene 412, the Layers tab 460 and the Properties tab 430 may be presented in their respective areas 406 and 404.

In some embodiments, the list of elements 472 may include an App Store Button 472E. In these and other embodiments, the App Store Button 472E may be dragged and positioned on the scene 412 in the Canvas View tab 410, similar to the other elements of the list of elements 472. In these and other embodiments, a positioned App Store Button may have properties similar to the properties of other elements. For example, a positioned App Store button may include a name field, a placement field, a visibility field, a fill field, a store ID field for an application store from Apple, a store ID field for an application store from Google, other digital application store identifications, a URL, and/or other fields. In some embodiments, a positioned App Store Button may be repositioned, may be resized, may have a background color and/or transparency, and may include text which may be edited, resized, recolored, highlighted, inverted, or angled. In these and other embodiments, the completed interactive media may open a store application associated with the digital application stores associated with Apple, Google, other digital application stores, and/or a web browser and direct the store application and/or web browser to the location identified in the associated field. As discussed above with respect to the Gesture Area element 472A, after placing an App Store Button 472E on the scene 412, the Layers tab 460 and the Properties tab 430 may be presented in their respective areas 406 and 404.

In some embodiments, the list of elements 472 may include a Replay Button 472F. In these and other embodiments, the Replay Button 472F may be dragged and positioned on the scene 412 in the Canvas View tab 410, similar to the other elements of the list of elements 472. In these and other embodiments, a positioned Replay Button may have properties similar to those of other elements. In some embodiments, a positioned Replay button may include a Name field, a placement field, a visibility field, a fill field, and a scene field. In these and other embodiments, the scene field may include a dropdown box which may include all of the scenes in the current project. In some embodiments, a positioned Replay Button may be repositioned, may be resized, may have a background color and/or transparency, and may include text which may be edited, resized, recolored, highlighted, inverted, or angled. In some embodiments, a completed interactive media item may proceed to the scene selected in the dropdown box in response to receiving input (such as a touch) on the positioned Replay Button. For example, in response to receiving input on the positioned Replay Button, the completed interactive media item may start over from the beginning. As discussed above with respect to the Gesture Area element 472A, after placing a Replay Button 472F on the scene 412, the Layers tab 460 and the Properties tab 430 may be presented in their respective areas 406 and 404.

In some embodiments, the list of elements 472 may include a Close Button 472G. In these and other embodiments, the Close Button 472G may be dragged and positioned on the scene 412 in the Canvas View tab 410, similar to the other elements of the list of elements 472. In these and other embodiments, a positioned Close Button may have properties similar to those of other elements. In some embodiments, a positioned Close button may include a name field, a placement field, a visibility field, and a fill field. In some embodiments, a positioned Close Button may be repositioned, may be resized, may have a background color and/or transparency, and may include text which may be edited, resized, recolored, highlighted, inverted, or angled. In these and other embodiments, a completed interactive media item may close in response to receiving input (such as a touch) on the positioned Close Button. For example, when presented on a platform that permits exiting, the completed interactive media item may exit to a different screen. As discussed above with respect to the Gesture Area element 472A, after placing a Close Button 472G on the scene 412, the Layers tab 460 and the Properties tab 430 may be presented in their respective areas 406 and 404.

In some embodiments, the Elements tab may include an Open URL Button (not illustrated in FIG. 4). In these and other embodiments, the Open URL Button may be dragged and positioned on the scene 412 in the Canvas View tab 410, similar to the other elements. In these and other embodiments, a positioned Open URL Button may have properties similar to those of other elements. In some embodiments, a positioned Open URL button may include a name field, a placement field, a visibility field, a fill field, and an open URL field. In some embodiments, a positioned Open URL Button may be repositioned, may be resized, may have a background color and/or transparency, and may include text which may be edited, resized, recolored, highlighted, inverted, or angled. In some embodiments, the completed interactive media item may open a web browser and direct the web browser to the URL in the open URL field in response to receiving input (such as a touch) on the Open URL Button. As discussed above with respect to the Gesture Area element 472A, after placing an Open URL Button on the scene 412, the Layers tab 460 and the Properties tab 430 may be presented in their respective areas 406 and 404.

As illustrated in FIG. 5, the UI 500, which may correspond with the UI 300 and the UI 400, may present different options and/or buttons in response to different selections of tabs. For example, to reach the UI 500 from the UI 400 of FIG. 4, a user may select the drag a Gesture Area element 572A from the list of elements 572 to the scene 512 to create the Gesture Area 516 and may reposition and/or resize the Gesture Area 516 in the scene 512. In response to placing the Gesture Area 516 in the scene 512, the Layers tab 560 in the Events & Actions/Layers area 506 and the Properties tab 530 in the Properties/Scenes area 504 may be presented with menus, information, and/or options associated with the placed Gesture Area 516.

The Layers tab 560 may include a Show All layers checkbox 562 in a particular scene 512 and/or in the current project (i.e., in every scene in the current project) and may include a list of layers 564 which may show a current layer, every layer in the scene 512, and/or every layer in the current project. For example, in some embodiments, receiving input in the Show All layers checkbox 562 may result in the UI 500 displaying every layer in the current project instead of limiting to layers in the scene 512. In some embodiments, each layer presented in the list of layers 564 may include options to select the layer, to show or hide the layer, to copy the layer, and/or to delete the layer.

In some embodiments, the Properties tab 530 may an element name field 532 to rename the element (in this case the Gesture Area 516), element position and visibility fields 534, which may include subfields to adjust the size and/or position of the element, a visibility of the element, and a background color of the gesture element, and an Add Gesture to Area dropdown box 536 to add one or more gestures to the Gesture Area 516. In some embodiments, the gestures may include sequences of input that, when received by the completed interactive media, cause the interactive media to take a particular action. In these and other embodiments, the gestures may include a tap 536A, a TouchDown 536B, a long press 536C, a swipe left 536D, a swipe right 536E, a swipe up 536F, a swipe down 536G, and other gestures. Alternatively or additionally, in some embodiments, the Add Gesture to Area dropdown box 536 may include more, fewer, or different gesture types. In some embodiments, multiple gestures may be associated with a single Gesture Area 516. Each gesture may be associated with different actions in a completed interactive media item. For example, each gesture result in the interactive media proceeding to a different scene. For example, a touch gesture 536A may result in the interactive media item proceeding to a first scene while a long press gesture 536C may result in the interactive media item proceeding to a second scene.

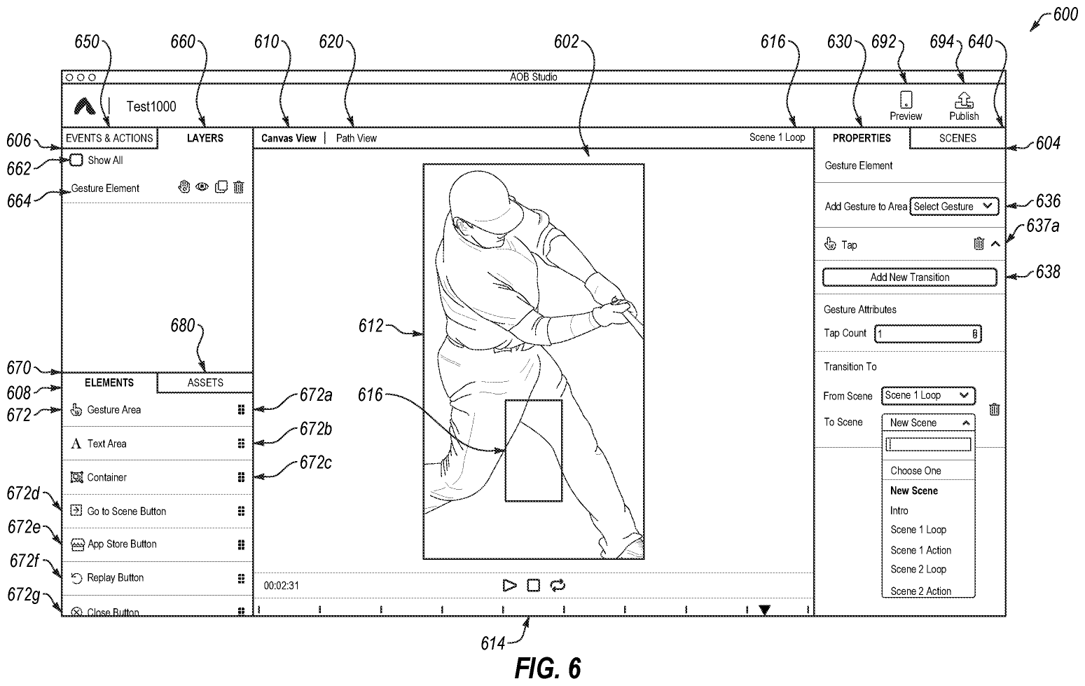

As illustrated in FIG. 6, the UI 600, which may correspond with the UI 300 of FIG. 3, the UI 400 of FIG. 4, and the UI 500 of FIG. 5, may present different options and/or buttons in response to different selections of tabs. For example, to reach the UI 600 from the UI 500 of FIG. 5, a user may select to add a Tap gesture 637a from the Add Gesture to Area dropdown box 636. In response to adding the Tap gesture 637a, an Add New Transition button 638 may be presented in the Properties tab 630. In some embodiments, after receiving input to select a particular gesture, such as the Tap gesture 637a, the UI 600 may add a new transition automatically. In these and other embodiments, a transition may move the completed interactive media from a first scene to a second scene. In some embodiments, transitions may be associated with repetitions of gestures, such as, for example, multiple taps. In some embodiments, the transition may include an originating scene, which may be automatically selected based on the scene 612 in which the gesture area 616 is placed. In some embodiments, a single gesture area 616 may be associated with multiple gestures, such as Tap gesture 637a, a Swipe Left gesture (not illustrated in FIG. 6), a long press (not illustrated in FIG. 6), and/or other gestures. In these and other embodiments, different gestures may be associated with different transitions, for example, a tap may transition from the scene 612 to a first scene while a long press may transition from the scene 612 to a second scene. Alternatively or additionally, in some embodiments, multiple distinct gestures may be associated with the same transition, for example, both a tap and a long press may transition from the scene 612 to a first scene.

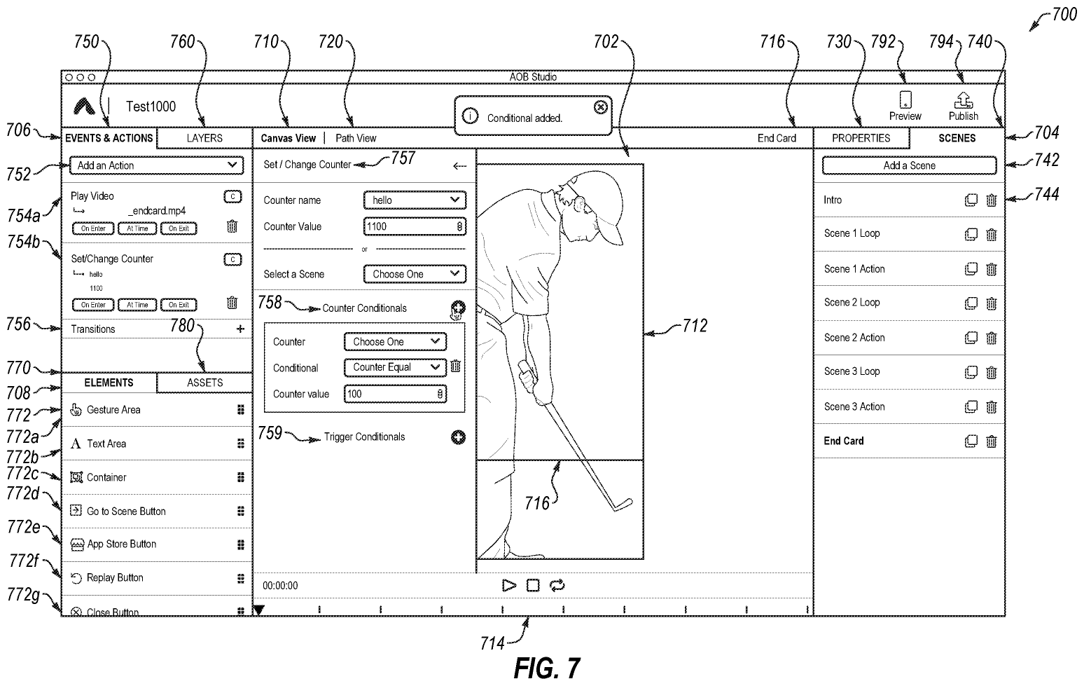

As illustrated in FIG. 7, the UI 700, which may correspond with the UI 300 of FIG. 3, the UI 400 of FIG. 4, the UI 500 of FIG. 5, and the UI 600 of FIG. 6, may present different conditional actions in the Events & Actions tab 706. As an example, to reach the UI 700 from the UI 600 of FIG. 6, a user may select the Add an Action button 752 and select to add a counter. In these and other embodiments, counters and/or triggers may be generated to provide additional control over how a completed interactive media item flows from one scene to another scene. As illustrated in FIG. 7, the scene 712 may include a Play Video action 754A and a Set/Change Counter action 754B.

In some embodiments, a counter may be set upon entering a scene. Alternatively or additionally, in some embodiments, a counter may be incremented on entering a scene. In these and other embodiments, the counter properties may include a counter name and a counter value 757. For example, in some embodiments, a counter may be incremented each time a particular scene is entered. In these and other embodiments, the particular scene may repeat until a counter trigger is reached, at which point the particular scene may transition to a different scene. For example, a counter may be associated with one or more counter conditionals 758 and/or trigger conditionals 759. Alternatively or additionally, the counter values may be changed arbitrarily, the counter values may have mathematical operations performed on them, two different counter values may have mathematical operations performed between them, and/or the counter values may be set by user input.

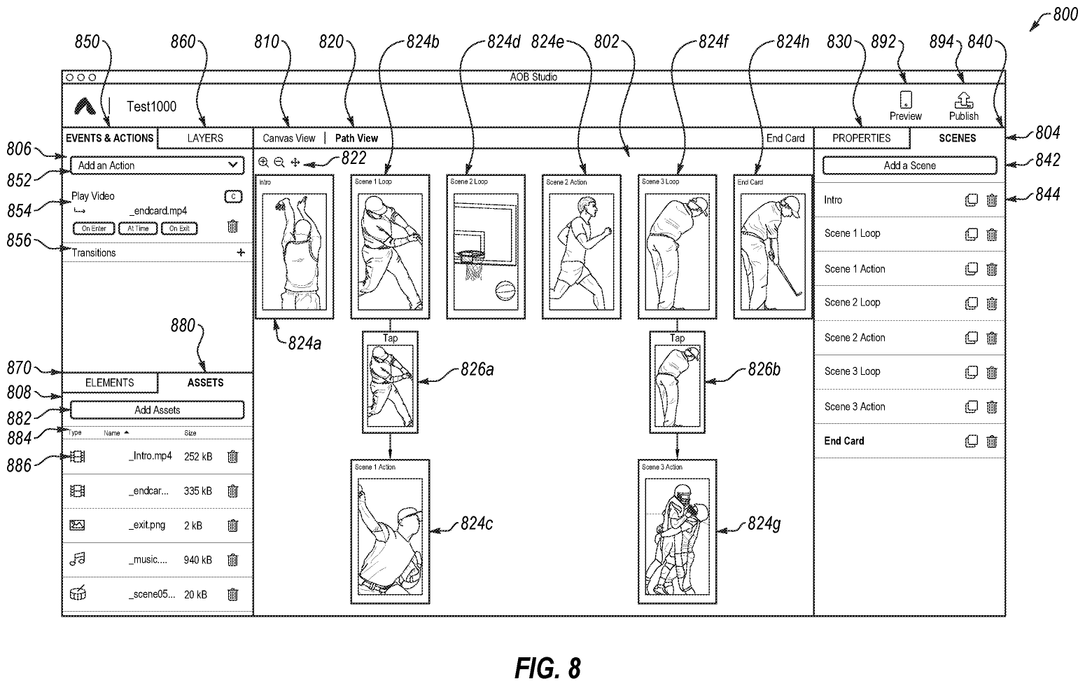

As illustrated in FIG. 8, the UI 800, which may correspond with the UI 300 of FIG. 3, the UI 400 of FIG. 4, the UI 500 of FIG. 5, the UI 600 of FIG. 6, and the UI 700 of FIG. 7, may present a “path” of the interactive media item in the Path View tab 820. In these and other embodiments, the Path View tab 820 may include navigation controls 822 which may facilitate easier navigation of the Path View tab 820, such as options to increase or decrease a zoom level or an option to move the displayed portion of the path. In some embodiments, the Path View tab 820 may include a graphical illustration of every scene in the current project. For example, the current project may include the eight scenes listed in the list of scenes 844. In these and other embodiments, each scene, 824a through 824h may be illustrated in the Canvas/Path area 802. In these and other embodiments, free-standing scenes, such as the scenes 824a, 824d, 824e, and 824h, may be illustrated on a first line and may not include any connections to any other scenes. In some embodiments, the Path View tab 820 may include lines illustrating transitions between scenes. For example, a line may indicate a transition from a first scene 824b, to a second scene 824c. In these and other embodiments, the action required for the transition may be indicated in the Path View tab 820 as the transitions 826. In this example, a Tap gesture on a Gesture Area may cause the interactive media item to transition from the scene 824b to the scene 824c. Similarly, a Tap gesture on a Gesture Area in scene 824f may cause the interactive media item to transition from scene 824f to scene 824g. In some embodiments, the Path View tab 820 may present a visual of the flow of the interactive media item and may help a user identify broken links, i.e., scenes that may never be encountered in the interactive media item (i.e., scenes other than a starting scene for which there is no transition to the scene) and scenes that may prevent the interactive media item from reaching its intended end (i.e., scenes other than an ending scene that do not have a transition to another scene).

In these and other embodiments, upon receiving input (for example, a mouse click) selecting a scene from the list of scenes 844 from the Scenes tab 840, events and actions associated with the scene may be displayed in the Events & Actions tab 850. For example, while the Path View tab 820 is presented, the scene 824a may be displayed without any transitions to other scenes. The scene 824a may then be selected from the list of scenes 844 in the Scenes tab 840, which may cause the Events & Actions associated with the scene 824a to be displayed in the Events & Actions tab 850. Upon receiving input, a transition may be added to the scene 824a to another scene, such as the scene 824b. When the Path View tab 820 is again presented, the new transition from the scene 824a to the scene 824b may be displayed. In some embodiments, the path between scenes may not be linear. For example, in some embodiments, the path may include a loop. For example, a later scene may return to a previous scene and/or one scene may transition to multiple different scenes.

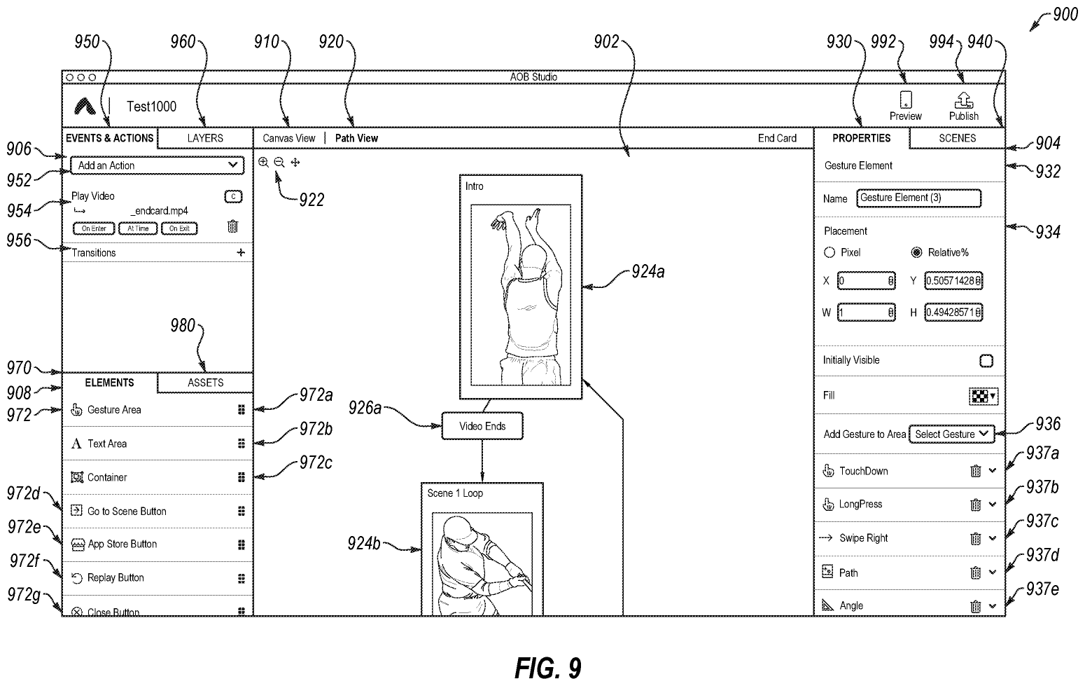

As illustrated in FIG. 9, the UI 900, which may correspond with the UI 300 of FIG. 3, the UI 400 of FIG. 4, the UI 500 of FIG. 5, the UI 600 of FIG. 6, the UI 700 of FIG. 7, and the UI 800 of FIG. 8, may present a completed path of the interactive media item in the Path View tab 920. As an example, to reach the UI 900 from the UI 800 of FIG. 8, a user may select each of the scenes illustrated in FIG. 8 without transitions and may order the scenes and generate transitions to create a desired flow for the interactive media item. Upon creating the desired flow, no scenes in the current project may be stranded scenes. As illustrated in FIG. 9, the scene 924a may transition to the scene 924b after completion of a video 926a associated with the scene 924a.

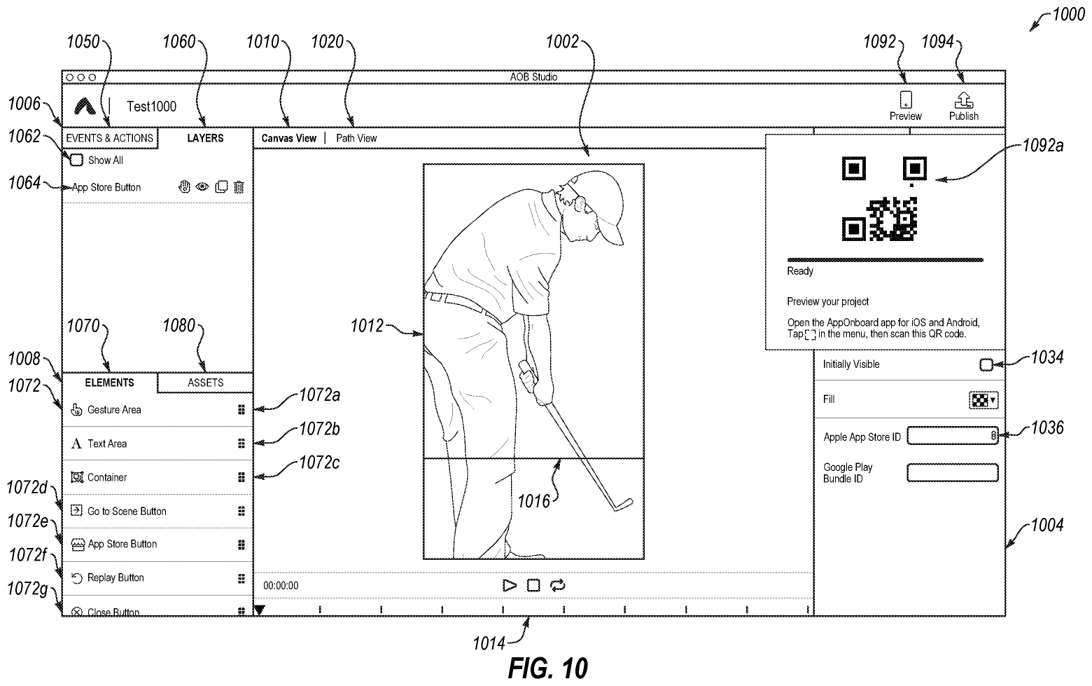

As illustrated in FIG. 10, the UI 1000, which may correspond with the UI 300 of FIG. 3, the UI 400 of FIG. 4, the UI 500 of FIG. 5, the UI 600 of FIG. 6, the UI 700 of FIG. 7, the UI 800 of FIG. 8, and the UI 900 of FIG. 9, may present a code (e.g., a quick response (QR) code) associated with the completed interactive media item. As an example, to reach the UI 900 from any of the Uls 300, 400, 500, 600, 700, 800, and 900 of FIGS. 3, 4, 5, 6, 7, 8, and 9, respectively, a user may select the Preview button 1092. In response to receiving input selecting the Preview button 1092 such as, for example, a mouse click, the UI 1000 may generate the interactive media item and may generate a matrix barcode such as a QR code to enable download of the interactive media item. In these and other embodiments, the matrix code may be associated with a download link to download the completed interactive media item. In the UI 1000 may also include a Publish button 1094. In response to receiving input selecting the Publish button 1094, the completed interactive media item may be uploaded in the appropriate format to a digital application store associated with Apple, Google, or other digital media providers, and/or a website.

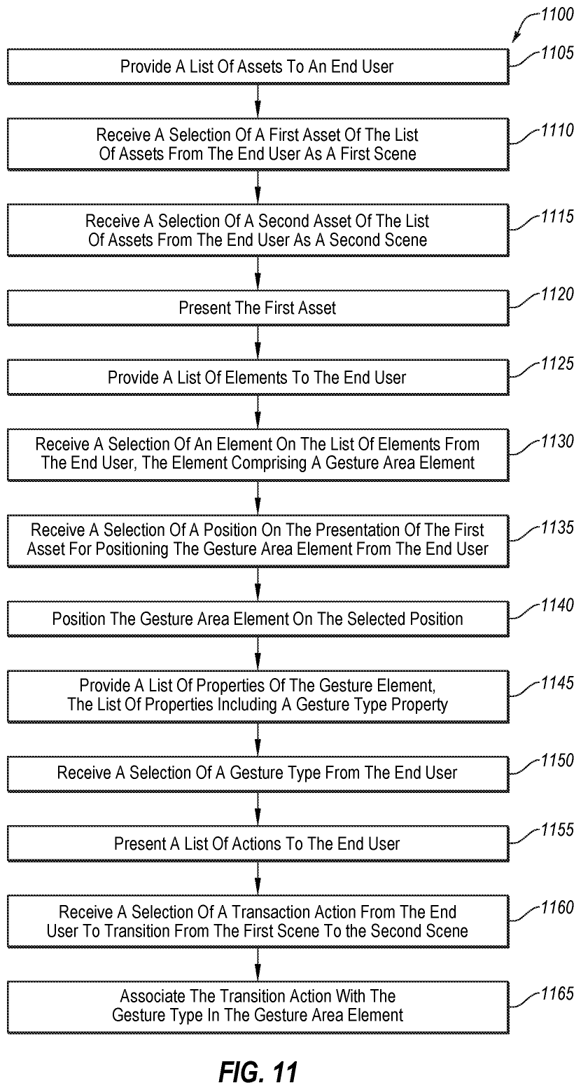

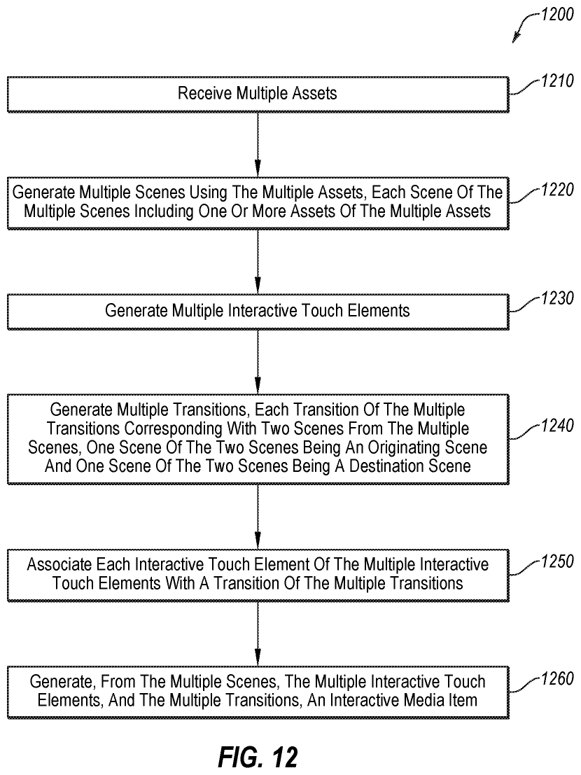

FIGS. 11-12 are flow diagrams illustrating methods for performing various operations, in accordance with some embodiments of the present disclosure, including performing editing functions of media data. The methods may be performed by processing logic that comprises hardware (e.g., circuitry, dedicated logic, programmable logic, microcode, etc.), software (e.g., instructions run on a processor to perform hardware simulation), or a combination thereof. Processing logic can control or interact with one or more devices, applications or user interfaces, or a combination thereof, to perform operations described herein. When presenting, receiving or requesting information from a user, processing logic can cause the one or more devices, applications or user interfaces to present information to the user and to receive information from the user.

For simplicity of explanation, the methods of FIGS. 11-12 are illustrated and described as a series of operations. However, acts in accordance with this disclosure can occur in various orders and/or concurrently and with other operations not presented and described herein. Furthermore, not all illustrated operations may be required to implement the methods in accordance with the disclosed subject matter. In addition, those skilled in the art will understand and appreciate that the methods could alternatively be represented as a series of interrelated states via a state diagram or events.

FIG. 11 is a flow diagram illustrating a method 1100 for generating an interactive media item. At block 1105, processing logic may provide a list of assets to an end user.

At block 1110, the processing logic may receive a selection of a first asset of the list of assets from the end user as a first scene. At block 1115, the processing logic may receive a selection of a second asset of the list of assets from the end user as a second scene.

At block 1120, the processing logic may present the first asset. At block 1125, the processing logic may provide a list of elements to the end user. At block 1130, the processing logic may receive a selection of an element of the list of elements from the end user. In some embodiments, the element may comprise a gesture area element.

At block 1135, the processing logic may receive a selection of a position on the presentation of the first asset for positioning the gesture area element from the end user. At block 1140, the processing logic may position the gesture area element on the selected position. At block 1145, the processing logic may provide a list of properties of the gesture element. In some embodiments, the list of properties may include a gesture type property.

At block 1150, the processing logic may receive a selection of a gesture type from the end user. At block 1155, the processing logic may present a list of actions to the end user. At block 1160, the processing logic may receive a selection of a transition action from the end user to transition from the first scene to the second scene. At block 1165, the processing logic may associate the transition action with the gesture type in the gesture area element.

FIG. 12 is a flow diagram illustrating a method 1200 for generating an interactive media item. At block 1210, processing logic may receive a multiple assets. At block 1220, the processing logic may generate multiple scenes using the multiple assets. Each scene of the multiple scenes may include one or more assets of the multiple assets. At block 1230, the processing logic may generate multiple interactive touch elements.

At block 1240, the processing logic may generate multiple transitions. Each transition of the multiple transitions may correspond with two scenes from the multiple scenes. One of the two scenes may be an originating scene and one of the two scenes may be a destination scene.

At block 1250, the processing logic may associate each interactive touch element of the multiple interactive touch elements with a transition of the multiple transitions. At block 1260, the processing logic may generate an interactive media item from the multiple scenes, the multiple interactive touch elements, and the multiple transitions.

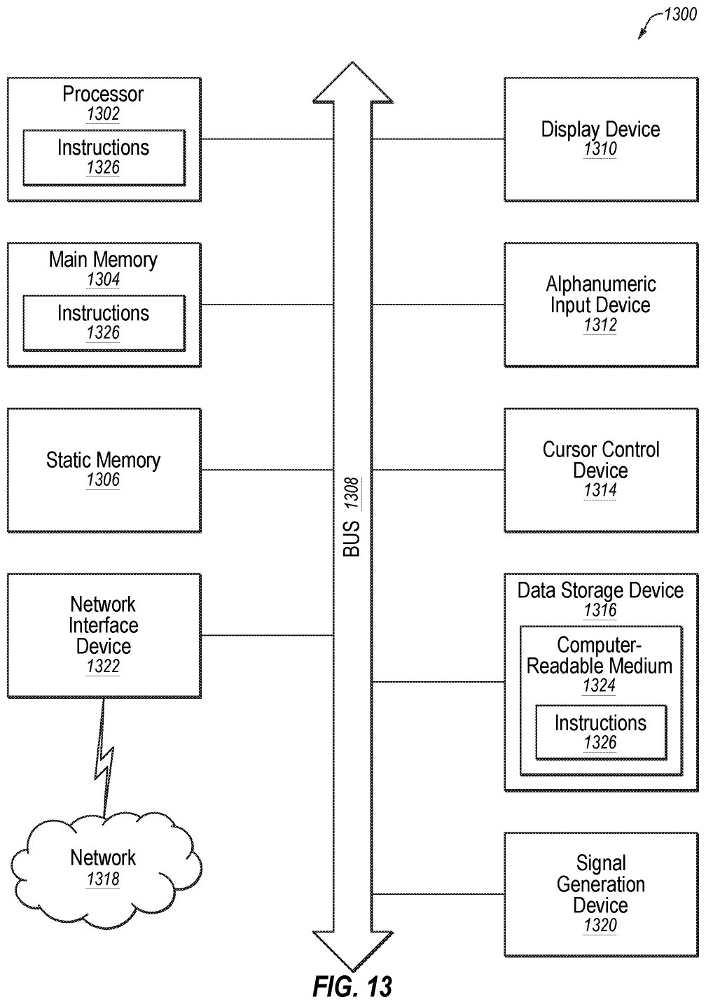

FIG. 13 illustrates a diagrammatic representation of a machine in the example form of a computing device 1300 within which a set of instructions, for causing the machine to perform any one or more of the methodologies discussed herein, may be executed. The computing device 1300 may be a mobile phone, a smart phone, a netbook computer, a rackmount server, a router computer, a server computer, a personal computer, a mainframe computer, a laptop computer, a tablet computer, a desktop computer etc., within which a set of instructions, for causing the machine to perform any one or more of the methodologies discussed herein, may be executed. In alternative embodiments, the machine may be connected (e.g., networked) to other machines in a LAN, an intranet, an extranet, or the Internet. The machine may operate in the capacity of a server machine in client-server network environment. The machine may be a personal computer (PC), a set-top box (STB), a server, a network router, switch or bridge, or any machine capable of executing a set of instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein.

The example computing device 1300 includes a processing device (e.g., a processor) 1302, a main memory 1304 (e.g., read-only memory (ROM), flash memory, dynamic random access memory (DRAM) such as synchronous DRAM (SDRAM)), a static memory 1306 (e.g., flash memory, static random access memory (SRAM)) and a data storage device 1316, which communicate with each other via a bus 1308.

Processing device 1302 represents one or more processing devices such as a microprocessor, central processing unit, or the like. More particularly, the processing device 1302 may be a complex instruction set computing (CISC) microprocessor, reduced instruction set computing (RISC) microprocessor, very long instruction word (VLIW) microprocessor, or a processor implementing other instruction sets or processors implementing a combination of instruction sets. The processing device 1302 may also be one or more special-purpose processing devices such as an application specific integrated circuit (ASIC), a field programmable gate array (FPGA), a digital signal processor (DSP), network processor, or the like. The processing device 1302 is configured to execute instructions 1326 for performing the operations and steps discussed herein.

The computing device 1300 may further include a network interface device 1322 which may communicate with a network 1318. The computing device 1300 also may include a display device 1310 (e.g., a liquid crystal display (LCD) or a cathode ray tube (CRT)), an alphanumeric input device 1312 (e.g., a keyboard), a cursor control device 1314 (e.g., a mouse) and a signal generation device 1320 (e.g., a speaker). In one implementation, the display device 1310, the alphanumeric input device 1312, and the cursor control device 1314 may be combined into a single component or device (e.g., an LCD touch screen).

The data storage device 1316 may include a computer-readable storage medium 1324 on which is stored one or more sets of instructions 1326 embodying any one or more of the methodologies or functions described herein. The instructions 1326 may also reside, completely or at least partially, within the main memory 1304 and/or within the processing device 1302 during execution thereof by the computing device 1300, the main memory 1304 and the processing device 1302 also constituting computer-readable media. The instructions may further be transmitted or received over a network 1318 via the network interface device 1322.

While the computer-readable storage medium 1324 is shown in an example embodiment to be a single medium, the term “computer-readable storage medium” should be taken to include a single medium or multiple media (e.g., a centralized or distributed database and/or associated caches and servers) that store the one or more sets of instructions. The term “computer-readable storage medium” shall also be taken to include any medium that is capable of storing, encoding or carrying a set of instructions for execution by the machine and that cause the machine to perform any one or more of the methodologies of the present disclosure. The term “computer-readable storage medium” shall accordingly be taken to include, but not be limited to, solid-state memories, optical media and magnetic media.

In the above description, numerous details are set forth. It will be apparent, however, to one of ordinary skill in the art having the benefit of this disclosure, that embodiments of the disclosure may be practiced without these specific details. In some instances, well-known structures and devices are shown in block diagram form, rather than in detail, in order to avoid obscuring the description.

Some portions of the detailed description are presented in terms of algorithms and symbolic representations of operations on data bits within a computer memory. These algorithmic descriptions and representations are the means used by those skilled in the data processing arts to most effectively convey the substance of their work to others skilled in the art. An algorithm is here and generally, conceived to be a self-consistent sequence of steps leading to a desired result. The steps are those requiring physical manipulations of physical quantities. Usually, though not necessarily, these quantities take the form of electrical or magnetic signals capable of being stored, transferred, combined, compared and otherwise manipulated. It has proven convenient at times, principally for reasons of common usage, to refer to these signals as bits, values, elements, symbols, characters, terms, numbers, or the like.

It should be borne in mind, however, that all of these and similar terms are to be associated with the appropriate physical quantities and are merely convenient labels applied to these quantities. Unless specifically stated otherwise as apparent from the above discussion, it is appreciated that throughout the description, discussions utilizing terms such as “identifying,” “subscribing,” “providing,” “determining,” “unsubscribing,” “receiving,” “generating,” “changing,” “requesting,” “creating,” “uploading,” “adding,” “presenting,” “removing,” “preventing,” “playing,” or the like, refer to the actions and processes of a computer system, or similar electronic computing device, that manipulates and transforms data represented as physical (e.g., electronic) quantities within the computer system's registers and memories into other data similarly represented as physical quantities within the computer system memories or registers or other such information storage, transmission or display devices.

Embodiments of the disclosure also relate to an apparatus for performing the operations herein. This apparatus may be specially constructed for the required purposes, or it may comprise a computer selectively activated or reconfigured by a computer program stored in the computer. Such a computer program may be stored in a non-transitory computer readable storage medium, such as, but not limited to, any type of disk including floppy disks, optical disks, CD-ROMs and magnetic-optical disks, read-only memories (ROMs), random access memories (RAMs), EPROMs, EEPROMs, magnetic or optical cards, flash memory, or any type of media suitable for storing electronic instructions.

The words “example” or “exemplary” are used herein to mean serving as an example, instance, or illustration. Any aspect or design described herein as “example’ or “exemplary” is not necessarily to be construed as preferred or advantageous over other aspects or designs. Rather, use of the words “example” or “exemplary” is intended to present concepts in a concrete fashion. As used in this application, the term “or” is intended to mean an inclusive “or” rather than an exclusive “or”. That is, unless specified otherwise, or clear from context, “X includes A or B” is intended to mean any of the natural inclusive permutations. That is, if X includes A; X includes B; or X includes both A and B, then “X includes A or B” is satisfied under any of the foregoing instances. In addition, the articles “a” and “an” as used in this application and the appended claims should generally be construed to mean “one or more” unless specified otherwise or clear from context to be directed to a singular form. Moreover, use of the term “an embodiment” or “one embodiment” or “an implementation” or “one implementation” throughout is not intended to mean the same embodiment or implementation unless described as such. Furthermore, the terms “first,” “second,” “third,” “fourth,” etc. as used herein are meant as labels to distinguish among different elements and may not necessarily have an ordinal meaning according to their numerical designation.

The algorithms and displays presented herein are not inherently related to any particular computer or other apparatus. Various systems may be used with programs in accordance with the teachings herein, or it may prove convenient to construct a more specialized apparatus to perform the required method steps. The required structure for a variety of these systems will appear from the description below. In addition, the present disclosure is not described with reference to any particular programming language. It will be appreciated that a variety of programming languages may be used to implement the teachings of the disclosure as described herein.

The above description sets forth numerous specific details such as examples of specific systems, components, methods and so forth, in order to provide a good understanding of several embodiments of the present disclosure. It will be apparent to one skilled in the art, however, that at least some embodiments of the present disclosure may be practiced without these specific details. In other instances, well-known components or methods are not described in detail or are presented in simple block diagram format in order to avoid unnecessarily obscuring the present disclosure. Thus, the specific details set forth above are merely examples. Particular implementations may vary from these example details and still be contemplated to be within the scope of the present disclosure.

It is to be understood that the above description is intended to be illustrative and not restrictive. Many other embodiments will be apparent to those of skill in the art upon reading and understanding the above description. The scope of the disclosure should, therefore, be determined with reference to the appended claims, along with the full scope of equivalents to which such claims are entitled.

What is claimed is:

1. A method comprising:
providing a list of assets to an end user of an interactive media item creation platform;
receiving a selection of a first asset of the list of assets from the end user as a first scene;
receiving a selection of a second asset of the list of assets from the end user as a second scene;
presenting the first asset;
providing a list of elements to the end user;
receiving a selection of an element of the list of elements from the end user, the element comprising a gesture area element;
receiving a selection of a position on the presentation of the first asset for positioning the gesture area element from the end user;
positioning the gesture area element on the selected position;
providing a list of properties of the gesture area element, the list of properties including a gesture type property;
receiving a selection of a gesture type from the end user;
presenting a list of actions to the end user;
receiving a selection of a transition action from the end user to transition from the first scene to the second scene; and
associating the transition action with the gesture type in the gesture area element.

2. The method of claim 1, wherein the assets of the list of assets include one or more of: videos, images, and audio.

3. The method of claim 1, wherein the elements of the list of elements include one or more of: a gesture area element, a text area element, a container element, a close button, an open link element, and an app store button.

4. The method of claim 1, wherein the gesture type includes one or more of: a tap, a touchdown, a long press, a swipe left, a swipe right, a swipe up, and a swipe down.

5. The method of claim 1, further comprising:
providing a list of conditional requirements associated with the gesture type; and
receiving a selection of a conditional requirement from the end user,
wherein the transition action is further associated with the conditional requirement.

6. The method of claim 1, further comprising:
receiving a selection of a third asset of the list of assets from the end user;
receiving a selection of a position on the presentation of the first asset for positioning the third asset from the end user; and
positioning the third asset on the selected position.

7. The method of claim 1, further comprising:
presenting, in a path area, a diagram of the first scene and the second scene, the first scene connected with the second scene using the gesture type.

8. The method of claim 1, further comprising:
generating, from the first scene, the second scene, the gesture type, and the transition action, an interactive media item.

9. At least one non-transitory computer readable medium configured to store one or more instructions that when executed by at least one system perform the method of claim 1.

10. A method comprising:
receiving a plurality of assets;
generating a plurality of scenes using the plurality of assets, each scene of the plurality of scenes including one or more assets of the plurality of assets;
generating a plurality of interactive touch elements;
generating a plurality of transitions, each transition of the plurality of transitions corresponding with two scenes from the plurality of scenes, one scene of the two scenes being an originating scene and one scene of the two scenes being a destination scene;
associating each interactive touch element of the plurality of interactive touch elements with a transition of the plurality of transitions; and
generating, from the plurality of scenes, the plurality of interactive touch elements, and the plurality of transitions, an interactive media item.

11. The method of claim 10, wherein the assets of the plurality of assets include one or more of: videos, images, and audio.

12. The method of claim 10, wherein the plurality of interactive touch elements include one or more gestures of: a tap, a touchdown, a long press, a swipe left, a swipe right, a swipe up, and a swipe down.

13. The method of claim 10, further comprising:
providing the interactive media item to a computing device via a wireless network connection.

14. The method of claim 10, further comprising:
providing the interactive media item to an application store.

15. The method of claim 10, further comprising:
generating a plurality of conditional elements; and
associating each conditional element of the plurality of conditional elements with a transition of the plurality of transitions,
wherein the interactive media item is further generated from the plurality of conditional elements.

16. At least one non-transitory computer readable medium configured to store one or more instructions that when executed by at least one system perform the method of claim 10.

17. A system comprising:
a memory; and
a processing device coupled with the memory, the processing device being configured to:
receive a plurality of assets;
generate a plurality of scenes using the plurality of assets, each scene of the plurality of scenes including one or more assets of the plurality of assets;
generate a plurality of interactive touch elements;
generate a plurality of transitions, each transition of the plurality of transitions corresponding with two scenes from the plurality of scenes, one scene of the two scenes being an originating scene and one scene of the two scenes being a destination scene;
associate each interactive touch element of the plurality of interactive touch elements with a transition of the plurality of transitions; and
generate, from the plurality of scenes, the plurality of interactive touch elements, and the plurality of transitions, an interactive media item.

18. The system of claim 17, wherein the assets of the plurality of assets include one or more of: videos, images, and audio.

19. The system of claim 17, wherein the plurality of interactive touch elements include one or more gestures of: a tap, a touchdown, a long press, a swipe left, a swipe right, a swipe up, and a swipe down.

20. The system of claim 17, further comprising:
a network communication device coupled with the memory and the processing device, the network communication device configured to:
transmit the interactive media item to a computing device via one or more wireless communication networks; and
transmit the interactive media item to an application store.
